(19) United States
(12) Patent Application Publication
(10) Pub. No.: US 2024/0257256 A1
(43) Pub. Date: Aug. 1, 2024

(54) ASSET MANAGEMENT METHODS AND SYSTEMS

(71) Applicant: Brian Richard Fast, Kirtland, OH (US)

(72) Inventor: Brian Richard Fast, Kirtland, OH (US)

(21) Appl. No.: 18/479,783

(22) Filed: Oct. 2, 2023

Related U.S. Application Data
(60) Provisional application No. 63/412,113, filed on Sep. 30, 2022.

(51) Int. Cl. G06Q 40/06; G06Q 30/0645; G06Q 50/16

(52) U.S. Cl. CPC G06Q 40/06; G06Q 30/0645; G06Q 50/16

(57) ABSTRACT

Computer-implemented asset management methods, systems, and computer-readable media are described.

### RELATED APPLICATIONS

This application claims the benefit of U.S. Application No. 63/412,113, entitled “Asset Management Methods And Systems,” filed on Sep. 30, 2022, which is incorporated herein by reference in its entirety.

### FIELD

Some implementations are generally related to computerized asset management, and, more particularly, to methods and systems for asset management including full life cycle asset management from pre-acquisition due diligence to asset disposal utilizing data structures representing an asset, subunits of the asset, and associated functions.

### BACKGROUND

Evaluating, acquiring, and managing assets, such as real estate assets, can often be a labor-intensive manual process that can involve inspecting and quickly gathering information about an asset on-site and in-person. This information then takes significant time to compile and analyze prior to making a decision on whether to acquire the asset. Then, assuming the asset is acquired, the stabilization process and stabilized operation process may not be able to readily make use of due diligence information depending on how the due diligence information was gathered and processed.

Inefficiencies in some conventional techniques during pre-acquisition due diligence, stabilization, and stabilized operational phases of asset management have a direct impact on the rate of return for investment in the asset. A need may exist for systems and methods of computerized asset management that can provide greater data sharing, data storage reduction, and reduced time durations across all phases of asset management from pre-acquisition due diligence to stabilization and from stabilized operation to asset disposal (e.g., selling the asset).

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example asset management system and a network environment which may be used for one or more implementations described herein.

FIG. 2 is a diagram of an example asset management application and associated functional modules or units in accordance with some implementations.

FIG. 3A is a diagram of an example asset management graphical user interface arranged in a horizontal configuration in accordance with some implementations.

FIG. 3B is a diagram of an example asset management graphical user interface arranged in a vertical configuration with a tree view in accordance with some implementations.

FIG. 4 is a diagram of an example asset management working environment in accordance with some implementations.

FIG. 5A is a diagram of an example asset data structure in accordance with some implementations.

FIG. 5B is a diagram of an example asset management graphical user interface including a checkerboard element in accordance with some implementations.

FIG. 5C is a diagram of an example asset management graphical user interface including a three-dimensional visualization in accordance with some implementations.

FIG. 5D is a diagram of an example asset management IA/AI process in accordance with some implementations.

FIG. 6A is a diagram showing an example of a detailed portion of an example asset data structure in accordance with some implementations.

FIG. 6B is a diagram showing processing of a work project associated with a building in accordance with some implementations.

FIG. 7 is a flowchart of an example method of asset management in accordance with some implementations.

FIG. 8 is a block diagram of an example computing device which may be used for one or more implementations described herein.

FIG. 9 is a diagram showing a customer partner program module in accordance with some implementations.

FIG. 10 is a diagram showing an example computer-implemented asset management lifecycle process in accordance with some implementations.

FIG. 11 is a diagram showing an example tree view user interface in accordance with some implementations.

FIG. 12 is a diagram showing an example tree view user interface with tab elements in accordance with some implementations.

FIG. 13 is a diagram showing an example user interface for notification configuration in accordance with some implementations.

FIG. 14 is a diagram showing an example user interface for notification configuration in accordance with some implementations.

### DETAILED DESCRIPTION

In general, some implementations can include holistic workflows, core functionality for managing any asset, and additional features for specific use cases or different applications integrated into a single application. As used herein, a holistic workflow can include the notion that an implementation can provide IDE-like features. Within the software development industry, an IDE is an integrated development environment. Some implementations can provide features for asset management analogous to those features provided by an IDE for software development. For example, one or more implementations can support all functionality (e.g., end to end asset management support) within a single software framework, users have access to the same data, data should only be entered once, and the system functions with available data.

In some implementations, a core feature can include an ability to help a user focus on identifying and solving the most significant problem limiting profitability and wealth generation from a real estate portfolio. This can include improving the planning and coordination processes to help reduce timelines and increase ROI. The ROI is increased through reduced expenses by improving project schedules, increased revenue through quicker unit turns, improved automated notifications and offsite oversite to identify issues with operations, and reduced timeline for stabilization refinance.

One example use case of an implementation described herein is management of a multi-family or single-family rentals assets. This example is used for the purpose of illustrating some example aspects of the disclosed subject matter and is not intended to be limiting. There are other use cases or applications that additional features of an implementation can support. For example, some implementations can be configured to support additional use cases including, but not limited to, mobile homes, short term rentals, storage units, commercial properties, so called “fix and flip” properties, design build projects, equipment tracking, farms, equipment heavy industries, and other tangible and intangible assets. Further, additional use cases can include general business using the features described below in connection with property management.

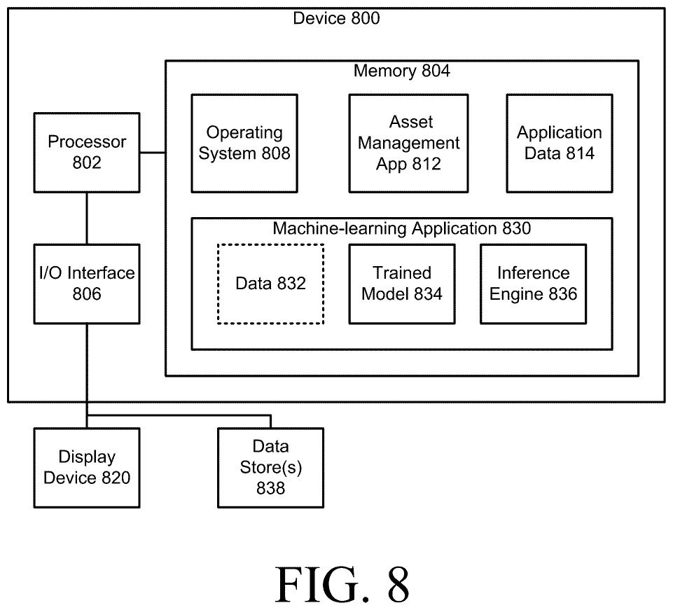

When performing asset management functions, it may be helpful for a system to suggest one or more asset management tasks or parameters and/or to make predictions about profitability of an asset. To make predictions or suggestions, a probabilistic model (or other model as described below in conjunction with FIG. 8) can be used to make an inference (or prediction) about aspects of asset management such as profitability or investor return. Accordingly, it may be helpful if the probability inference regarding a probability that an asset can be acquired and produce a desired rate of return on capital (or other measure of investment or business performance). Other aspects of an asset under consideration for acquisition or under management can be predicted or suggested as described below.

The inference based on the probabilistic model can include predicting potential asset profitability, investment return, or the like in accordance with asset management parameters (or other data) analysis and confidence score as inferred from the probabilistic model. The probabilistic model can be trained with data including previous asset management data. Some implementations can include generating asset management predictions based on asset management parameters. The inference can also include a recommendation to acquire an asset following an acquisition and/or due diligence data gathering phase.

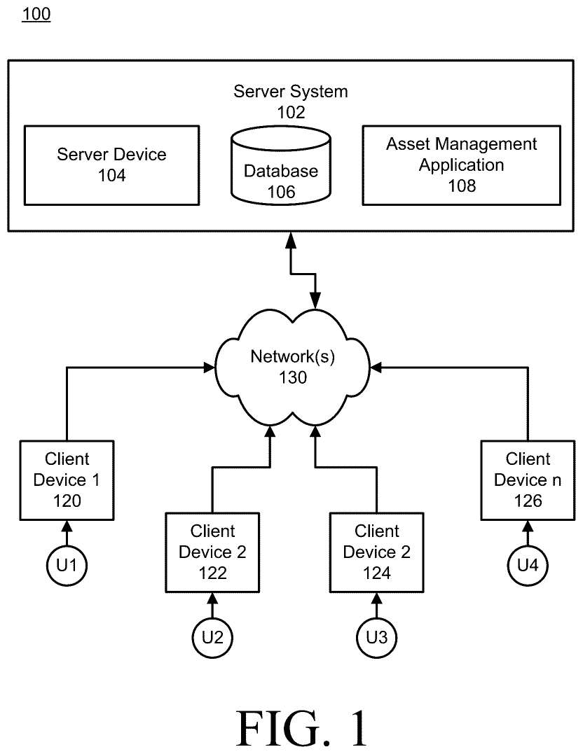

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and an asset management application 108. The asset management application can manage or be associated with one or more items or users (132-136). For example, the asset management application can be configured to manage assets (e.g., real estate assets, investments, etc.) or any physical or virtual asset that may benefit from an asset management application or system. Network environment 100 also can include one or more client devices, e.g., customer devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, database 106, and asset management application 108, and shows four blocks for customer devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, embedded system, medical equipment, programmable logic controllers (PLCs), connected sensors, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective customer devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective customer devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on customer devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more customer devices 120-126 can provide asset management functions as described herein.

Various implementations of features described herein can use any type of system and/or service. Any type of electronic device can make use of the features described herein. Some implementations can provide one or more features described herein on customer (client) or server devices disconnected from or intermittently connected to computer networks.

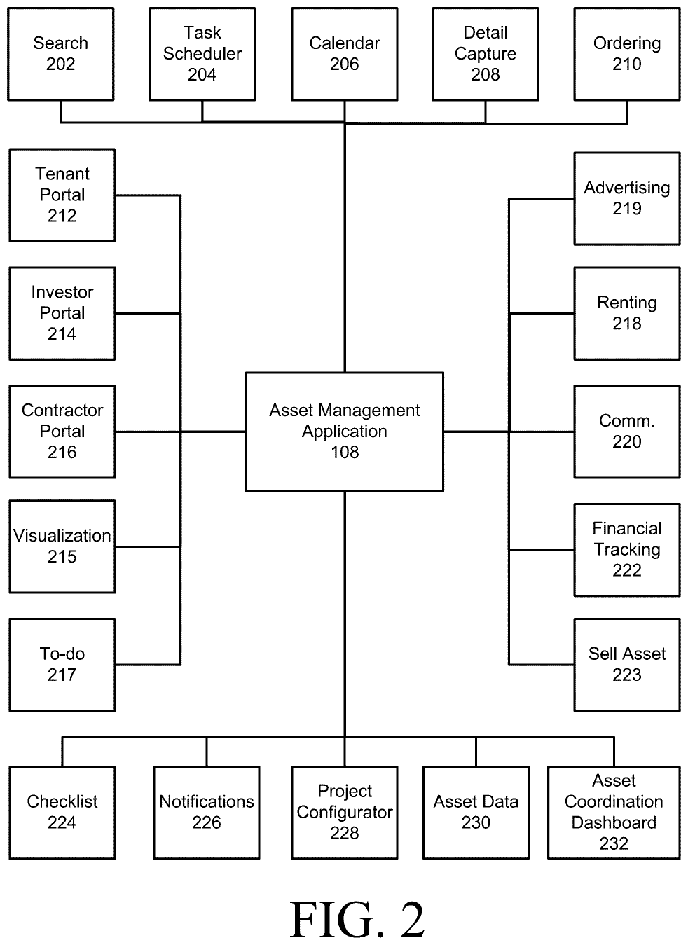

FIG. 2 is a diagram of an example asset management application and associated functional modules or units in accordance with some implementations. In particular, the asset management application 108 can include one or more modules or functional units such as a search module 202, a task scheduler 204, a calendar 206, a detail capture module 208, an ordering module 210, a tenant portal 212, an investor portal 214, a visualization module 215, a contractor portal 216, a to-do module 217, a renting module 218, an advertising module 219, a communication module 220, a financial tracking module 222, a sell asset module 223, a checklist/action item module 224, a notifications module 226, a project configurator 228, asset data 230, and asset coordination dashboard 232.

In operation, search module 202 is configured to search the asset management application data. The task scheduler module 204 is configured to create new tasks, edit tasks, delete tasks and mark the status of tasks. Calendar 206 is configured to provide calendar functions to users.

Detail capture module 208 is configured to capture details about an asset from a user. For example, a user with a mobile device can capture asset divisions (e.g., building, units, rooms, etc.) of an asset such as a property asset and can also capture details associated with each division of the asset. The details can be captured in formats including photos, videos, audios, etc. and can include location information, date and time, etc. The details can also include information such as whether a maintenance or repair task needs to be performed on the asset division associated with the detail record. The details can be stored in an asset data structure as discussed in greater detail below.

In some implementations, the detail capture module 208 can be used (e.g., when on site to inspect or gather due diligence information on an asset) to create and/or populate the main data structure to record the as is condition of a particular feature of the asset under evaluation (e.g., building, unit, room, etc.). The detail capture module 208 can include features to create (or add) custom data types for asset specific workflows. The detail capture module 208 can also include voice command or voice recognition functionality to enter data. For example, during an inspection or tour of a subject property, a user can activate the detail capture module 208 voice to text functionality, which can capture voice input from the user regarding a given division or area of the property (e.g., a building, unit, or room) and condition or other details about the given area. Also, if the given area of the property is not already present in the configuration or data structure the system can add an element to the data structure corresponding to the given area. The detail capture module 208 can also be configured to receive other types of data from one or more sensors such as position/location information (e.g., GPS data or the like), image data (still image, video, depth map, etc.), distance/measurement data, temperature data, moisture content data, fluid pressure data, electrical power data, or the like. The detail capture module 208 can add the received sensor data to a detail of the data structure portion corresponding to a given area of the property. Further, the detail capture module can include image recognition (e.g., either via an internal or external image recognition process or service) for auto configuring information such as recognizing objects or portions of a property, corresponding details (such as equipment age or estimated age, condition, model, year manufactured or installed, etc.) and adding that information to the corresponding data structure portion. In some implementations, the detail capture module can execute on a user or client device (e.g., 120-126), on a server (e.g., 102), or a combination of the two. In some implementations, the detail capture module 208 can be used to create and/or populate the main data structure to record the as is condition of a particular feature of the asset under evaluation (e.g., building, unit, room, etc.) through a 3D CAD environment with drag and drop capabilities. In some implementations, the detail capture module 208 can be used (e.g., when on site to inspect or gather due diligence information on an asset) to create and/or populate the main data structure to record the future state of a particular feature of the asset under evaluation (e.g., building, unit, room, etc.).

The ordering module 210 is configured to order supplies for projects including major projects, one-time repairs, one time maintenance, or for periodic maintenance or the like. This module includes preferred items due to price, availability, preference that should be used. When adding an item, it could include the necessary parts as well. For example, a hot water tank would include additional unions, shut off values, and materials for pressure relief. When adding an item, it would not only add the pricing, but it could also include known lead times, and provide an ability to order the part through the same system.

Once asset relationships, structure and data are set up (e.g., data and structure of an asset data structure and data 230 captured via the detail capture module 208) an implementation can provide a method of managing the operations (e.g., maintain an existing asset and generating revenue) and projects (e.g., investments that increase revenue) within the single environment. From this environment, portals permit access to the same data and performing actions for necessary users, e.g., tenant portal 212, investor portal 214, and contractor portal 216, as described below.

Each asset type or division can be configured to be leased. When management desires to rent the asset, it can be advertised on multiple sites to identify prospective tenants via advertising module 219. When someone wishes to rent the asset, the prospective tenant can create a tenant user account with the required information via the renting module 218. The asset management system can collect an application fee, check if the information passes the preliminary check, and run a background check on the prospective tenant. If the prospective tenant passes the predefined criteria, then the prospective tenant can be placed on a prospective tenant list for management approval and placement (e.g., through the renting module 218). When management and tenant agree to proceed with leasing the asset, management will communicate with the tenant, via the tenant portal 212, the appropriate move in date, the tenant user account will be associated with the asset (or in queue once current tenant moves out), leases will be created and stored, and additional documents will be generated and stored. Email and text messages can be routed through the software for visibility and data retention.

The investor portal 214 permits investors to identify and evaluate opportunities, and view data and metrics relevant to the investment, such as ROI, etc. The investor portal 214 can include a process that begins with identifying available opportunities and continues to performing a basic review on the available opportunities (i.e., a coarse filter), performing details review where the data structure correspond to the asset begins to get built and a financial analysis is started. The process continues to an in-depth financial evaluation of the asset. For assets that meet the investor's criteria, the process continues with securing the asset (e.g., through acquisition), beginning work to stabilize and operate the asset, and tracking the asset in terms of operations and financials.

Visualization module 215 provides visualization of various aspects of the asset. For example, visualization can be based on one or more factors of an asset such as leased units, occupancy, etc. In general, data coming from the detail capture 208, financial tracking module 22, and/or notifications module 226 can be visualized, along with other data. The detailed visualization display can be configurable to include custom code to display KPIs or be utilized for specific KPIs in the future.

The contractor portal 216 is used for contractors to provide quotes, receive work orders, and provide progress reports.

The to-do module 217 can manage to-do lists for each asset or asset portion (e.g., building or unit). Managing to-do lists can include accepting new to-do list items, providing reminders of to-do list items via the notifications module, and tracking the status of a to-do list item from creating to closing as completed.

The communication module 220 can be configured to communicate with users in one or more communications channels such as email, text message, etc.

The financial tracking module 222 can be configured to track financial aspects of an asset including money in (e.g., rent), money out (e.g., operations costs, maintenance costs, repair costs, remodeling/updating costs, etc.). Output of the financial tracking module 222 can be provide to other modules such as the visualization module 215, investor portal 214, and sell asset module 223.

Selling asset module 223 can be configured to perform functions for an asset selling process including advertising to internal and external lists. The sale of the asset can also include a digital asset including the data structure representing the asset and the data gathered about the asset from the initial evaluation stages through the stabilization and operational phases. This data can be used to generate reports that can be compared to tax filings to assure a prospective buyer of the accuracy of the data. The system can also generate a confidence metric based on the accuracy of the system data.

In some implementations, each asset type shall include a unique action list maintained by checklist/action item module 224. This can include a log that tracks events related to the asset (e.g., charge, expense, project expense, maintenance, or the like), items that need to be done (e.g., tasks), and software changes. The action list can serve as a single place to monitor what is “happening” with the asset.

The notification module 226 is configured to provide notifications to one or more users about required responses to data events, Financial Tracking 222, Renting 218 (which includes Leasing), to-do items 217, calendar items 206, and/or checklist items. The notification module 226 can also be configured to provide notifications when an aspect of an asset or asset subdivision such as occupancy, rent, lease, repairs, rate of return, etc. reach a threshold value. In some implementations, the notification module 226 can be configured to provide automatic notifications based on best practices or standard operating procedures. In some implementations, the notification module 226 can be configured with custom notification based on custom events. For example, a notification can be sent when a lease is expiring but there is not a move out date yet for the tenant in the system. In another example, when an occupant is moving out, a notification can be sent to remind management to line up the next occupant. In some implementations, the notification module can include intelligent automation/artificial intelligence (IA/AI) features to automatically provide notifications. For example, the IA/AI notifications module can prompt an operations manager or worker to take an action according to an SOP. A set of General SOP Tasks could be preconfigured with what is needed and whom shall be assigned the work. Each General SOP Task could be associated with a notification such that when a specific notification occurs a specific SOP Task shall be created. This enabled General SOP Tasks to be updated in one location but automatically assigned to an individual, role, group, or assigned role.

The project configurator 228 provides an ability to quickly create a software data structure based on a preconfigured file or a setup wizard. For example, how many buildings, units per building, authorized users and roles, user groups, and aliased roles.

Regarding the asset data 230, the asset data 230 can comprise a main data structure that can include a data structure representing asset such as a property and any associated divisions such as buildings, units, rooms, or the like. The asset data structure can also include other data such as project reports, financial reports and key progress indicators (KPIs). The main data structure (or configuration) can be used to initially set up the asset relationship (e.g., main data structure describing asset types and details) and actual configurations (e.g., specific values).

Asset coordination dashboard 232 a single location where critical information is presented in a meaningful way for planning and coordination.

Managing many assets can be a daunting task. This typically requires multiple users to be responsible for interacting with the asset. To help manage the asset, each actionable task can be assigned to a specific user. Each user, upon login, shall have a To-do List showing what's been assigned to them and remain open. To further help manage the asset, specific notifications (e.g., faults and alarms or actionable event) can be created to quickly identify and inform specific individuals of a (potential) problem or indicate action is required. For an operator to better view the current activities and run weekly meetings, visualizations generated by the visualization module 215 can be used. Some implementations can include the ability to display and sort action logs within a single window.

In some implementations, core features that improve the user experience such as a general Search function, Calendar, Help Request, and Project Configurator. Search shall create a list of Assets, Details, Scopes, Quotes, Invoices, Corrective Actions that include the “search phrase.” A Calendar (or Gant chart) shall exist for visualizing time dependent items (project work, scheduled tasks and maintenance). Help Request shall provide mechanism for a user to “raise” their hand for help. Project Configurator shall clearly show all relationship dependencies and provide a method of loading data.

The final core features include a Custom Checklist and Specific Checklist. The Custom Checklist is located on the main page. It includes an expandable pane in which multiple tabs (or some method for including multiple lists). This shall be a method identifying what's necessary for the overall objectives. This can include creating or opening things such as a standard operating procedure, basic training content, or coordinating higher level tasks. The same feature shall provide a method to create specific instances (usually much smaller in scope) associated with an Asset or Scope, i.e., a move in ready checklist. Note: when “completing” certain items, when appropriate, automatic notifications should be sent.

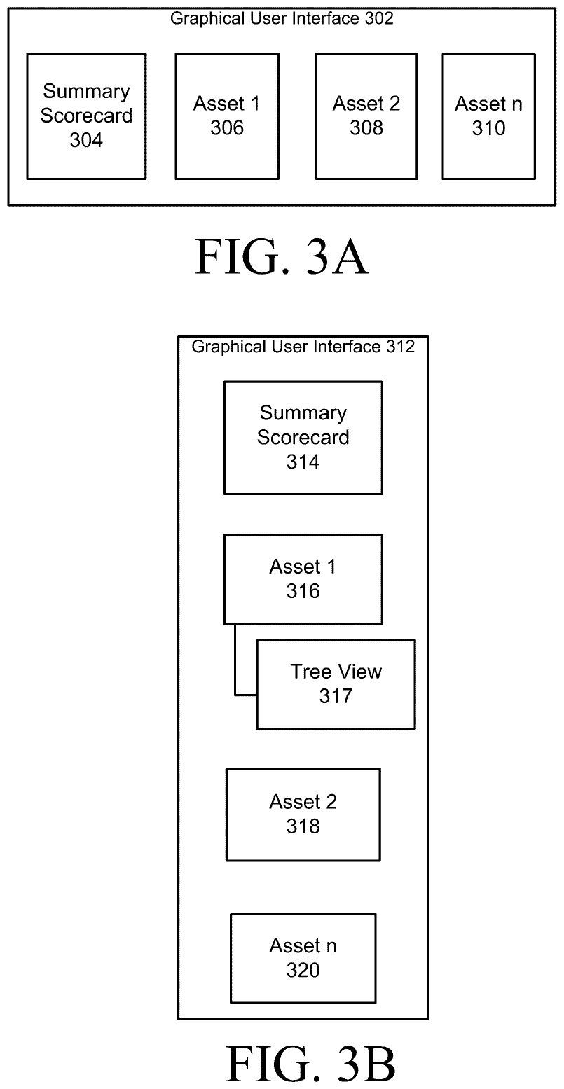

FIG. 3A is a diagram of an example asset management graphical user interface 302 arranged in a horizontal configuration in accordance with some implementations. The user interface 302 can include a summary scorecard 304 and individual asset cards (306-310) the asset cards can represent assets or portions of assets (e.g., buildings or apartments). For example, when logging in each apartment (asset type) can be represented by a unique card; in which the summary score would report that critical information and KPIs for all apartments (asset types).

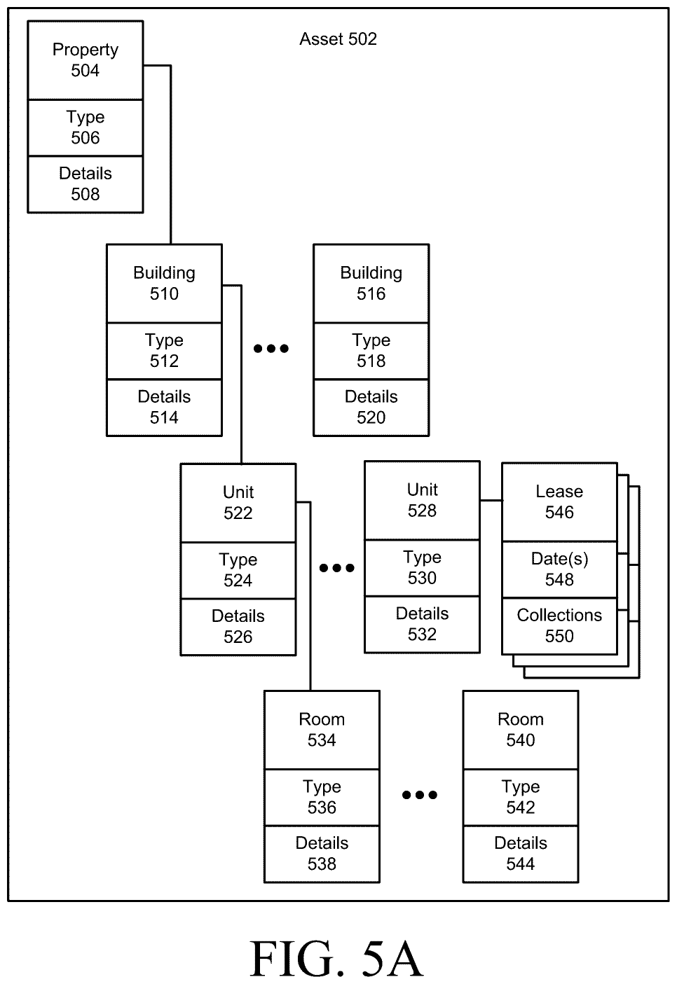

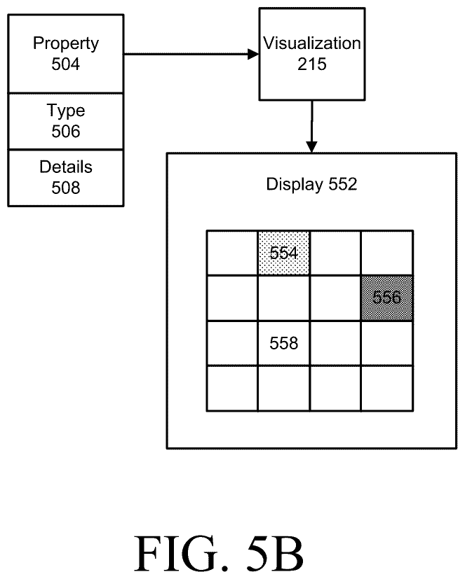

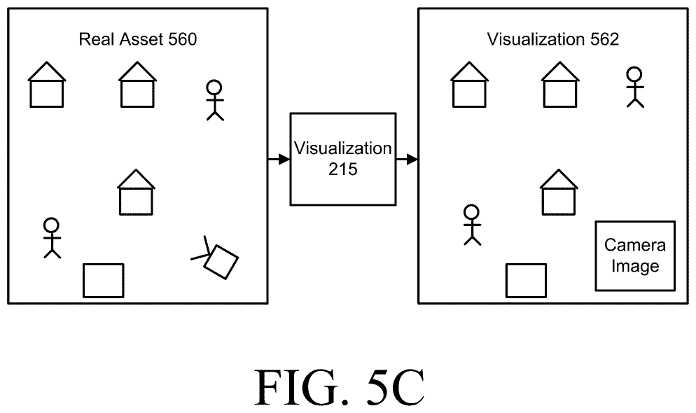

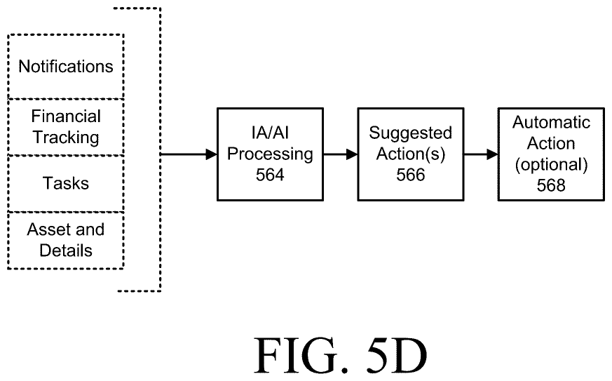

FIG. 3B is a diagram of an example asset management graphical user interface 312 arranged in a vertical configuration with a tree view in accordance with some implementations. The vertical user interface 312 includes a summary scorecard 314 and one or more asset cards 316-320. The graphical user interface 312 also includes a tree view 317. The tree view 317 is shown in greater detail in FIG. 5A. Some implementations of the property management system and method disclosed herein may not include the tree data structure but can include one or more of the other feature described herein.

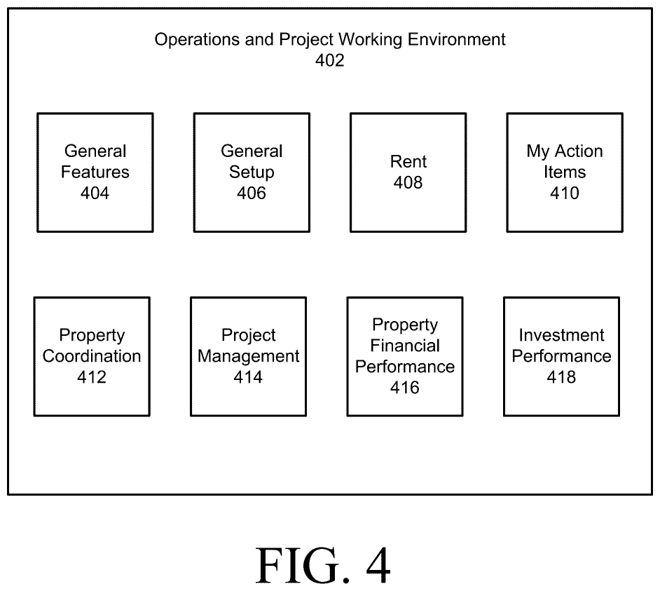

FIG. 4 is a diagram of an example asset operations and project working environment 402 in accordance with some implementations. The operations and project working environment 402 can include user interface elements to access general features 404, general setup 406, rent 408, my action items 410, property coordination 412, project management 414, property financial performance 416, and investment performance 418.

For example, within the primary environment which will be used for Operations and Project 402, there are panes (e.g., collection of features to support necessary workflows) for General Features 404 (e.g., search, schedular, calendar, checklists, help me), General Setup 406 (e.g., alias association and asset specific configurations), Rent 408 (asset specific configurations for advertising for the entire asset), My Action Items 410 (To-do List, Notifications, Correspondences), Property Coordination 412 (e.g., overall visualization, KPIs, Detailed Visualization-centrally coordinating operations and projects, Vacant & Applicant lists, Gannt Charts visually illustrating dependency's), Project Management 414 (e.g., Details (As Is state), Scopes, Quotes, PO's, Invoices, Corrective Actions, Gannt Chart visually illustrating dependencies, KPIs, Autogenerate Done reports & Lender draw requests, Autogenerate progress project reports, Export spreadsheets), Property financial performance 416 (e.g., evaluation based on “known” information, Contracts, Autogenerate progress financial reports, Export spreadsheet), and Investment performance 418 (apply different lending scenarios to evaluate the investment opportunity, when desired push to desired buyer lists, and autogenerate necessary contracts).

FIG. 5A shows a diagram of an example asset 502 data structure that includes a property 504 and associated type 506 and details 508. The property 504 can include one or more buildings (510 and 516), which each include respective type (512, 518) and details (514, 520). Each building (510, 516) can include one or more units (522, 528), which each include respective types (524, 530) and details (526, 532). Each unit (522, 528) includes one or more rooms (534, 540), which each include a type (536, 542) and details (538, 544).

Some implementations can include a core ability to define an asset and associations via one or more data structures that are constructed based on the specific details of each asset. In some implementations, the types within an asset hierarchy can include a property, building, unit, and room. A property (e.g., 504) typically would exist with a class designation describing the functionality and which dictates complimentary features. Some example class designations of properties can include, but are not limited to, a multi-family apartment property, a single-family rental property, etc. In the property definition, pertinent (general) information shall be stored (not associated with a specific asset).

As shown in FIG. 5, a property 504 may include multiple buildings (510, 516) associated with the property 504. For each building (510, 516), multiple units (522, 528) may be associated with a respective building (e.g., 510 or 516). For each unit (522, 528), multiple rooms (534, 540) may be associated with a respective unit (e.g., 522 or 528). An ability to create a room can serve two purposes. First, this feature provides a mechanism to add a desired level of granularity when defining the as is condition of a unit (and, in turn, a corresponding building and/or property). For example, this feature provides a mechanism to define (or add to the data structure) unit structural features such as a closet, a mechanical room, a utility room, a hallway, a den, a porch or lanai, a dining room, etc. Secondly, the feature of room-level granularity within the data structure of an implementation provides an ability of the implementation to support “renting” each room to a different respective tenant when desired (e.g., renting one multi-bedroom apartment to multiple individual tenants such as students renting an apartment near a college or university).

In some implementations, when an asset data structure or an element of the data structure is instantiated, that element cannot be moved or deleted. However, it can be “hidden” (e.g., minimized or made not visible in a graphical user interface) to remove it from service such that it can restored be unhiding the asset (minimizes someone really messing something up and minimizes development).

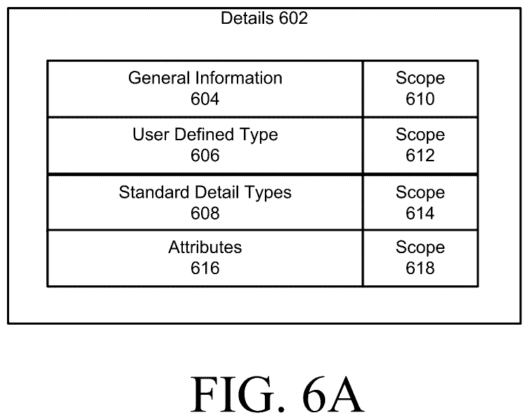

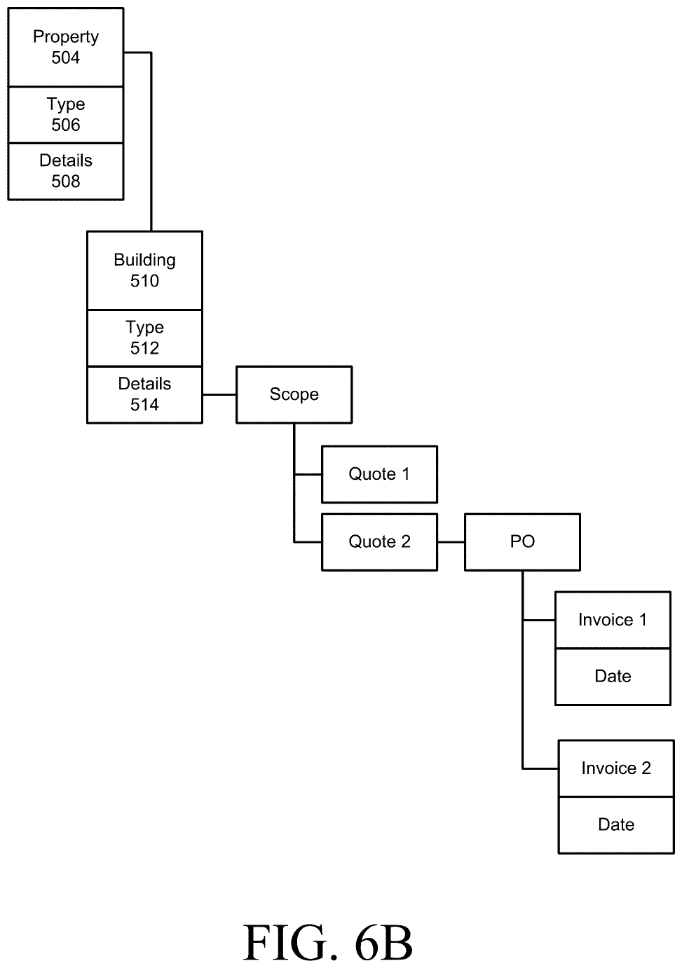

Each asset instance (and/or sub-data structures) can include a unique details list (e.g., 508, 514, 520, 526, 532, 538, and 544). An example details data structure is shown in FIG. 6A and described below.

Each asset type shall include an ability to track and schedule all revenue and expenses (e.g., via the financial tracking module 222). This shall be accomplished through charge(s), expense(s), project expense(s), and maintenance. A charge will exist when that asset can generate revenue, i.e., configuration exists that indicates it is rentable. A charge shall include an ability to include multiple elements to support multiple revenue streams, i.e., services other than rent. An expense will exist when that asset has a general expense paid by the property, i.e., Insurance payment, utility bill paid by property, etc. A project expense will exist when an invoice associated with a detail and scope are paid, i.e., capital expenditure project or major unit turn. Based on the situation some items may be associated with an expense or maintenance. This consistency shall be up to the user. In general maintenance shall be used for “typical” maintenance items. Each of these features shall make payments via money transfer (ACH or credit card). In some instances, this may be performed through the Schedular to preplan payment.

FIG. 5B is a diagram of an example asset management graphical user interface in accordance with some implementations. In particular, as shown in FIG. 5B, data from a property data structure 504 can be provided as input to a visualization module 215. The visualization module 215 can generate a checkerboard-style ticker display 552 in which assets (or portions of assets) are represented by squares. The color of the squares can indicate the status of that asset or asset portion with regard to one or more metrics. For example, box 554 represents a first color (e.g., green) indicating that the status of the asset or asset portion represented by box 554 is within a given value range. Box 556 is a second color (e.g., red) that indicates that the status of the asset or asset portion represented by box 556 is outside an acceptable range or needs attention in some way (e.g., there are one or more notifications for the asset or asset portion). Box 558 is a third color (e.g., yellow) indicating that a value associated with the asset or asset portion represented by box 558 is at a warning level (e.g., between the acceptable and unacceptable ranges of a value). An advantage of the visualization display 552 is that a user can easily ascertain the status of one or more assets or asset portions with respect to one or more parameters at a glance. The checkerboard-style graphical user interface visualization can include the segmented circle dashboard display described below in Appendix A.

FIG. 5C is a diagram of an example asset management graphical user interface in accordance with some implementations. In this example, data from a physical asset 560 (e.g., a multi-unit housing complex) with multiple staff members is received by the visualization module 215, which generates a visualization 562. The visualization 562 can include a three-dimensional view of the asset including real-time (or near real-time) locations of the employees and/or material and also images from one or more video cameras positioned within the asset 560. In addition to showing the locations of employees and video camera feeds, the visualization 562 can include color coding (e.g., green, yellow, red, or the other color set) or other visual indication of the buildings of the asset to indicate the status of one or more parameters associated with a given building (e.g., vacancy, maintenance issues, notifications, etc.).

FIG. 5D is a diagram of an example asset management IA/AI process in accordance with some implementations. In particular, inputs such as notifications, financial tracking data, tasks, and assets and details (e.g., the data structure) are provided to an IA/AI processing module 564. The IA/AI processing module 564 processes the inputs and generates one or more suggested actions 566 and optionally automatically takes one or more actions 568.

FIG. 6A is a diagram showing an example of a detailed portion of an example asset data structure in accordance with some implementations. Some implementations permit a user to identify specific details associated with the asset type. For example, a property may have a detail that capture general information 604 like insurance policy or describes specific things like the north parking lot; a building may have a detail that describes the roof; a building may have multiple details associated with each exterior window. A unit provides great flexibility to support the users desired workflow. For example, a unit may include details associated with flooring and paint which captures the necessary information for the entire unit. However, a unit may include multiple rooms in which each room includes a detail for flooring and paint which captures the necessary information for that room. In a situation where a room is added for a mechanical room there may include details for hot water tank and furnace. In general, a detail can include a user defined data type 606 (for grouping “like” things throughout the property based on the user's preference), unique local name, general description, and photos. The details 602 can also include standard detail types 608 and attributes 616 each with associated scopes (614, 618 respectively). Based on the desired use the details may be sorted by associated location or functionality.

FIG. 6B is a diagram showing processing of a work project associated with a building 510 in accordance with some implementations. To support future projects each detail 514 shall include an ability to capture future work through a scope. A scope associated with a detail is a method to identify a specific scope of work associated with the detail. As such, the user should set up details and scopes based on how the project shall be tracked and bid by contractors. The scope(s) shall be sent out for bid where quote(s) received shall be associated with the scope(s). Based on many factors the user shall choose which specific quote(s) to proceed with the necessary work. A quote may be based on labor, material, labor and material. For material quotes it may be sourced from external sources. However, materials may also be ordered from the software's standard part list to simplify the buying process. The quote(s) shall be converted to a PO (purchase order) through a status change. In the example of FIG. 6B, quote 2 is converted to a PO.

In which the contractor shall communicate progress through the PO instance. All coordination and necessary proof that work is complete shall be captured in the PO. When the work for the PO is complete the worker shall create an Invoice (full or partial payment via multiple instances) associated with the PO. The user shall either accept the Invoice and make payment or initiate a corrective action associated with the Invoice to complete prior to Payment. When a PO is completely done then the original detail status shall change to replaced and the quote that became a PO shall become the new “as is” detail.

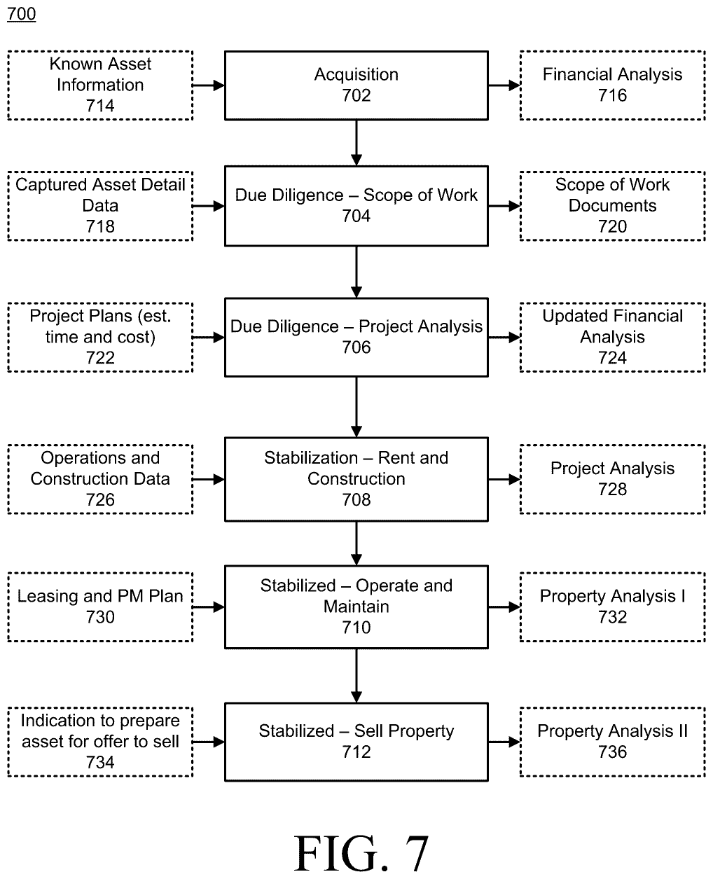

FIG. 7 is a flowchart of an example method of asset management in accordance with some implementations. The example method shown in FIG. 7 can be used for an asset having a property with a class designation of multi-family apartment property to manage the following steps of the asset life cycle:

Step 1: acquisition feasibility study 702 that uses known asset information 714 as input and generates a financial analysis 716 as output.

Step 2: due diligence scope of work 704 that uses captured asset detail data 718 as input and generates scope of work documents 720.

Step 3: due diligence project analysis 706 uses project plans (estimated time and cost) 722 as input and generates an update financial analysis 724.

Step 4: stabilization rent and construction 708 uses operations and construction data 726 as input and generates a project analysis 728.

Step 5: stabilized operate and maintain 710 uses a leasing and PM plan 730 as input and generates a property analysis I 732 as output.

Step 6: stabilized sell property 712 uses an indication to prepare asset for offer to sell 734 as input and generates a property analysis II as output.

An important feature includes the use case specific SOP Checklist. This “guides” the user through the entire process. The SOP checklist includes identifying what is necessary and illustrating how to enter the information into the software.

The primary user (manager or system administrator) can interact with the core functionality through the Property Configurator and other Visualization techniques based on the task. The software can automatically track and provide information for making decisions.

Step 1: The user shall integrate the properties known information to evaluate the current performance, create an Expected CapEx budget and forecast future rents, and evaluate the investment opportunity. When appropriate, generate a Letter of Intent to proceed to due diligence. Once an LOI is executed, the software can notify the user to proceed with due diligence.

During Step 2: The user can conduct a site visit to fully document the existing condition (property condition, rent roll, revenue, expenses, current situation and obligations). This needs to be performed extremely quickly. As such the software needs to be able to quickly capture information during the site visit for later analysis and evaluation. The software can have the ability for the user to define what scope of work is desired throughout the property. The software can automatically create an entire scope of work document to send out to contractors to bid. At some point in this process a purchase agreement can be created and accepted to proceed with more due diligence. It can be important to notify everyone that earnest money has been provided. It can be important to track when the earnest money goes hard to avoid scheduling issues that puts the earnest money in jeopardy.

During Step 3: The user can receive Quotes based on the Scope of work. The initial CapEx budget and performance summary can be updated based on the additional due diligence. The project is approved through underwriting, joint venture partners invest cash into the deal, a new LLC operating agreement is created, and the property is secured by the new entity.

During Step 4: The user can begin the stabilization process consisting of renovating and managing the property.

The renovation project can be managed through the Quotes, PO's, Invoices, and Corrective Actions. This can force each contractor to communicate and bill for work aligned with what the Lender expects. Once work is complete and approved, reports can be automatically generated to submit to the lender for payment. Additional phases may be associated with the renovation project for improved coordination.

The property operations can be managed through the leasing & collections, expenses, and maintenance. This can force the property manager to focus on KPIs of interest for the refinance.

When the contractors and property manager work through a common software platform everyone will know what's happening. This can permit the software to automatically notify someone when they're assigned a task.

The software can provide critical visualization screens for effectively managing the property. These include an Overview and Detailed Visualization. The Overview is like a stock board that's color coded based on different interests, e.g., revenue, occupancy, economic occupancy, project status, etc. The Detailed Visualization provides a method for monitoring KPIs and Action lists, for different Asset combinations, to access what is happening and determine what's not progressing.

The software can automatically track the Property, Building, and Unit KPIs for Leasing & Collections; Expenses; Maintenance; Projects. This can be used for analysis to drive action items.

During Step 5: The user can normally operate the complex. This phase is similar to Step 4 except it may begin to include future CapEx projects through defining scopes.

During Step 6: The user desires to sell the property. The software should assist in this objective through generating a certified sales report, generating sales contracts, and alert the buyer network about the opportunity.

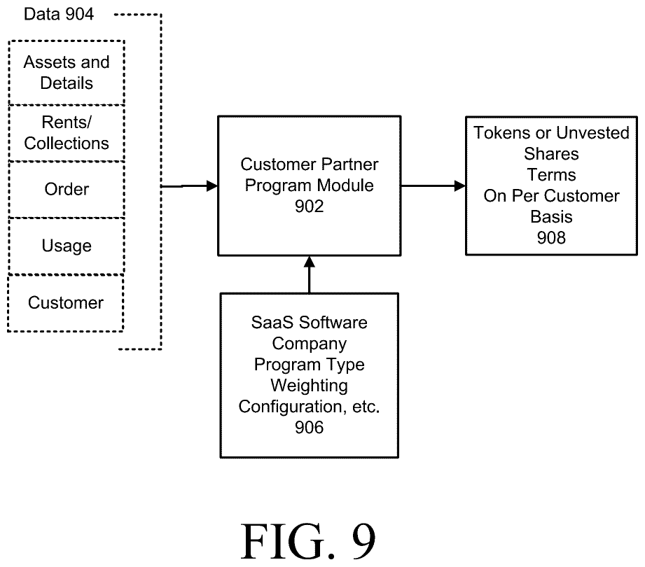

FIG. 9 is a diagram showing a customer partner program module in accordance with some implementations. FIG. 9 shows a customer partner program module 902 that receives data 904 as input and SaaS software company program data 906 and generates tokens or unvested shares on a per customer basis 908. The customer partner program is described in U.S. Patent Application No. 63/349,040, entitled “Customer Partner Program Methods And Systems,” and filed on Jun. 3, 2022, which is hereby by reference in its entirety.

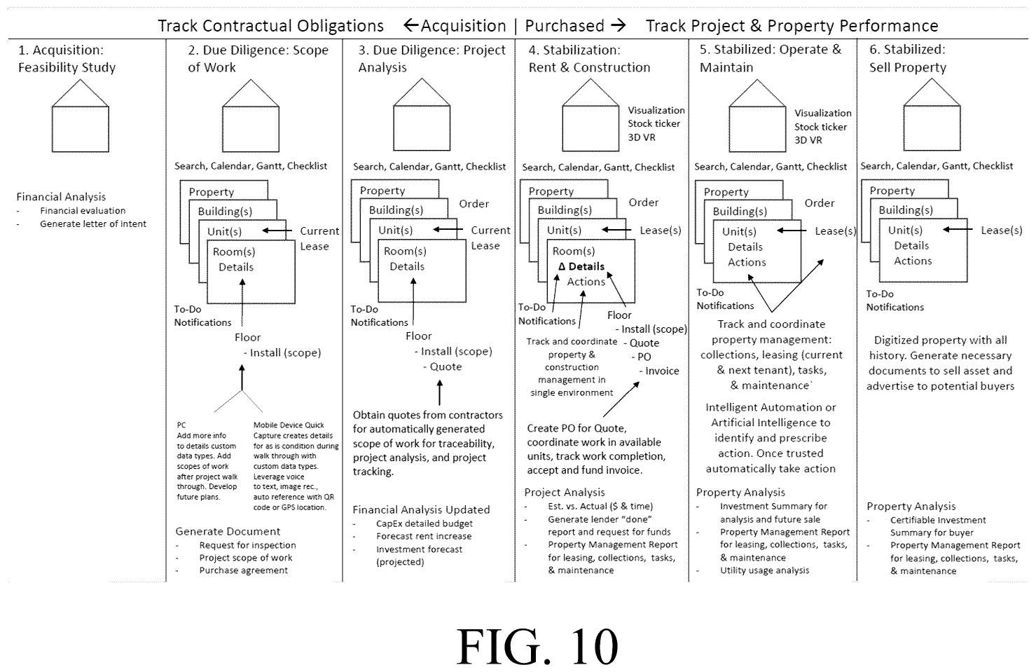

FIG. 10 is a diagram showing an example computer-implemented asset management lifecycle process in accordance with some implementations. As shown in FIG. 10, an implementation can support a process with six phases: 1) acquisition/feasibility study; 2) due diligence/scope of work; 3) due diligence/project analysis; 4) stabilization rent and construction; 5) stabilized/operate and maintain; and 6) stabilized/sell property. Details of each phase are shown in FIG. 10.

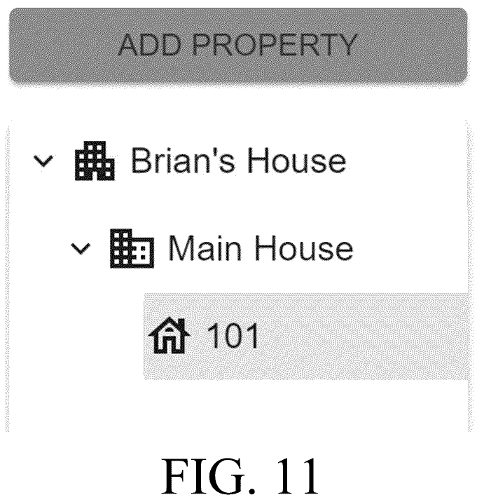

FIG. 11 is a diagram showing an example tree view user interface in accordance with some implementations. In particular, the tree view shows a hierarchical user interface for a property asset where a first level “Brian's House” includes a second level “Main House” and finally a third level “101” (e.g., an apartment).

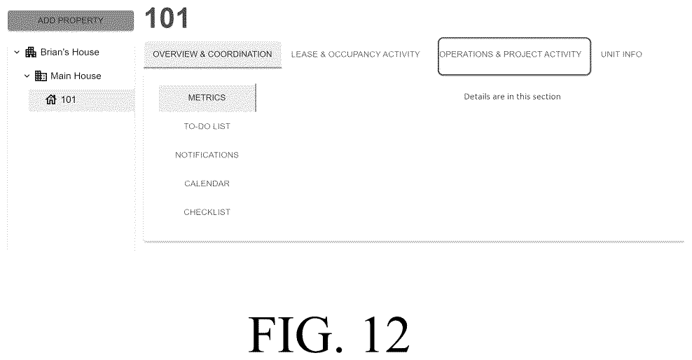

FIG. 12 is a diagram showing an example tree view user interface with tab elements in accordance with some implementations. In FIG. 12, the 101 element of the tree view is selected, and a tab user interface element is displayed, where the tabs include, for example, an Overview and Coordination tab, a Lease and Occupancy Activity tab, an Operations and Project Activity tab (selected), and a unit info tab. The Operations and Project Activity tab selections include metrics, to-do list, notifications, calendar, and checklist.

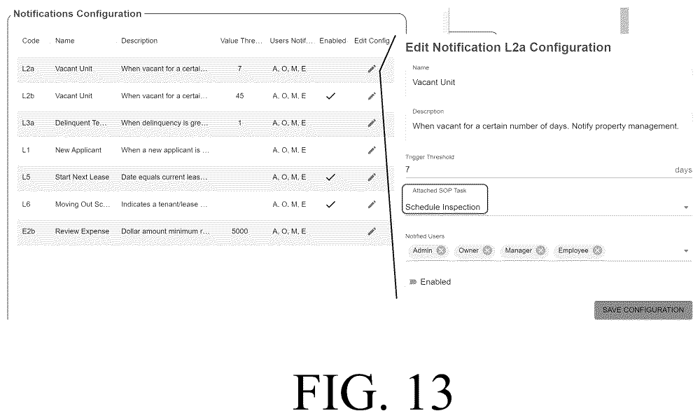

FIG. 13 is a diagram showing an example user interface for notification configuration in accordance with some implementations. In particular, FIG. 13 a list of notifications that can be configured. Each notification can be edited. For example, FIG. 13 shows a notification (“L2a”) edit window where the parameters of the notification can be configured including attaching an SOP task that can be attached to the notification and created when the notification is activated for a given subdivisions or portion of an asset. FIG. 13 also shows users (e.g., a user, a role, a group, or an alias) to be notified when the notification criteria are met.

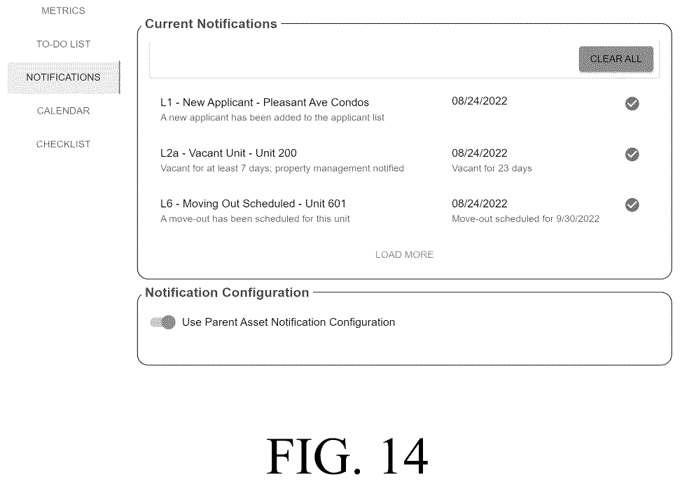

FIG. 14 is a diagram showing an example user interface for notification configuration in accordance with some implementations. In particular, the user interface includes current notifications and a user interface element for notification configuration that includes a control to select to use parent asset notification configuration, where elements of the asset data structure can inherit the notification settings of a parent asset subdivision (e.g., an apartment unit can inherit the notification configuration settings of a parent asset such as an apartment building).

FIG. 8 is a block diagram of an example device 800 which may be used to implement one or more features described herein. In one example, device 800 may be used to implement a client device, e.g., any of customer devices 120-126 shown in FIG. 1. Alternatively, device 800 can implement a server device, e.g., server device 104, etc. In some implementations, device 800 may be used to implement a client device, a server device, or a combination of the above. Device 800 can be any suitable computer system, server, or other electronic or hardware device as described above.

One or more methods described herein (e.g., 200 and/or 300) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, computations can be performed within the mobile app (and/or other apps) on the mobile computing device. In another example, computations can be split between the mobile computing device and one or more server devices.

In some implementations, device 800 includes a processor 802, a memory 804, and I/O interface 806. Processor 802 can be one or more processors and/or processing circuits to execute program code and control basic operations of the device 800. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 802 may include one or more co-processors that implement neural-network processing. In some implementations, processor 802 may be a processor that processes data to produce probabilistic output, e.g., the output produced by processor 802 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, machine-learning application 830, asset management application 812, and application data 814. Other applications may include applications such as a data display engine, web hosting engine, image display engine, notification engine, social networking engine, etc. In some implementations, the machine-learning application 830, and asset management application 812 can each include instructions that enable processor 802 to perform functions described herein, e.g., some or all of the method of FIG. 7.

The machine-learning application 830 can include one or more NER implementations for which supervised and/or unsupervised learning can be used. The machine learning models can include multi-task learning based models, residual task bidirectional LSTM (long short-term memory) with conditional random fields, statistical NER, etc. The Device 800 can also include an asset management application 812 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 830 may utilize Bayesian classifiers, support vector machines, neural networks, or other learning techniques. In some implementations, machine-learning application 830 may include a trained model 834, an inference engine 836, and data 832. In some implementations, data 832 may include training data, e.g., data used to generate trained model 834. For example, training data may include any type of data suitable for training a model for asset management tasks, such as parameters, labels, thresholds, etc. associated with asset management tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 834, training data may include such user data. In implementations where users permit use of their respective user data, data 832 may include permitted data.

In some implementations, data 832 may include collected data such as asset management parameters, asset management system data, etc. In some implementations, training data may include synthetic data generated for the purpose of training, such as data that is not based on user input or activity in the context that is being trained, e.g., data generated from simulated conversations, computer-generated images, etc. In some implementations, machine-learning application 830 excludes data 832. For example, in these implementations, the trained model 834 may be generated, e.g., on a different device, and be provided as part of machine-learning application 830. In various implementations, the trained model 834 may be provided as a data file that includes a model structure or form, and associated weights. Inference engine 836 may read the data file for trained model 834 and implement a neural network with node connectivity, layers, and weights based on the model structure or form specified in trained model 834.

Machine-learning application 830 also includes a trained model 834. In some implementations, the trained model 834 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 832 or application data 814. Such data can include, for example, images, e.g., when the trained model is used for asset management functions. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In different implementations, the trained model 834 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 834 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 832, to produce a result.

For example, training may include applying supervised learning techniques. In supervised learning, the training data can include a plurality of inputs (e.g., a set of images, electronic notes, data structures, etc. related to an asset) and a corresponding expected output for each input (e.g., predictions or suggestions representing aspects of an asset management project such as services, products, or operational actions needed or recommended). Based on a comparison of the output of the model with the expected output, values of the weights are automatically adjusted, e.g., in a manner that increases the probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to predict asset management parameters and/or select thresholds for parameters.

In another example, a model trained using unsupervised learning may cluster words based on the use of the words in data sources. In some implementations, unsupervised learning may be used to produce knowledge representations, e.g., that may be used by machine-learning application 830. In various implementations, a trained model includes a set of weights, or embeddings, corresponding to the model structure. In implementations where data 832 is omitted, machine-learning application 830 may include trained model 834 that is based on prior training, e.g., by a developer of the machine-learning application 830, by a third-party, etc. In some implementations, trained model 834 may include a set of weights that are fixed, e.g., downloaded from a server that provides the weights.

Machine-learning application 830 also includes an inference engine 836. Inference engine 836 is configured to apply the trained model 834 to data, such as application data 814, to provide an inference. In some implementations, inference engine 836 may include software code to be executed by processor 802. In some implementations, inference engine 836 may specify circuit configuration (e.g., for a programmable processor, for a field programmable gate array (FPGA), etc.) enabling processor 802 to apply the trained model. In some implementations, inference engine 836 may include software instructions, hardware instructions, or a combination. In some implementations, inference engine 836 may offer an application programming interface (API) that can be used by operating system 808 and/or asset management application 812 to invoke inference engine 836, e.g., to apply trained model 834 to application data 814 to generate an inference.

Machine-learning application 830 may provide several technical advantages. For example, when trained model 834 is generated based on unsupervised learning, trained model 834 can be applied by inference engine 836 to produce knowledge representations (e.g., numeric representations) from input data, e.g., application data 814. For example, a model trained for asset management tasks may produce predictions and confidences for given input information about an asset management project being proposed or planned. A model trained for predicting asset management parameters may produce a suggestion for one or more parameters of an asset management program. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 836.

In some implementations, knowledge representations generated by machine-learning application 830 may be provided to a different device that conducts further processing, e.g., over a network. In such implementations, providing the knowledge representations rather than the raw data may provide a technical benefit, e.g., enable faster data transmission with reduced cost.

In some implementations, machine-learning application 830 may be implemented in an offline manner. In these implementations, trained model 834 may be generated in a first stage and provided as part of machine-learning application 830. In some implementations, machine-learning application 830 may be implemented in an online manner. For example, in such implementations, an application that invokes machine-learning application 830 (e.g., operating system 808, one or more of asset management application 812 and/or other applications) may utilize an inference produced by machine-learning application 830, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 834, e.g., to update embeddings for trained model 834.

In some implementations, machine-learning application 830 may be implemented in a manner that can adapt to particular configuration of device 800 on which the machine-learning application 830 is executed. For example, machine-learning application 830 may determine a computational graph that utilizes available computational resources, e.g., processor 802. For example, if machine-learning application 830 is implemented as a distributed application on multiple devices, machine-learning application 830 may determine computations to be carried out on individual devices in a manner that optimizes computation. In another example, machine-learning application 830 may determine that processor 802 includes a GPU with a particular number of GPU cores (e.g., 1000) and implement the inference engine accordingly (e.g., as 1000 individual processes or threads).

In some implementations, machine-learning application 830 may implement an ensemble of trained models. For example, trained model 834 may include a plurality of trained models that are each applicable to the same input data. In these implementations, machine-learning application 830 may choose a particular trained model, e.g., based on available computational resources, success rate with prior inferences, etc. In some implementations, machine-learning application 830 may execute inference engine 836 such that a plurality of trained models is applied. In these implementations, machine-learning application 830 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 808 or one or more other applications, e.g., asset management application 812.

In different implementations, machine-learning application 830 can produce different types of outputs. For example, machine-learning application 830 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 830 may produce an output video with a particular effect applied, e.g., rendered in a comic-book or particular artist's style, when trained model 834 is trained using training data from the comic book or particular artist, etc. In some implementations, machine-learning application 830 may produce an output based on a format specified by an invoking application, e.g., operating system 808 or one or more applications, e.g., asset management application 812. In some implementations, an invoking application may be another machine-learning application. For example, such configurations may be used in generative adversarial networks, where an invoking machine-learning application is trained using output from machine-learning application 830 and vice-versa.

Any software in memory 804 can alternatively be stored on any other suitable storage location or computer-readable medium. In addition, memory 804 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. Interfaced devices can be included as part of the device 800 or can be separate and communicate with the device 800. For example, network communication devices, storage devices (e.g., memory and/or database 106), and input/output devices can communicate via I/O interface 806. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 806 can include one or more display devices 820 and one or more data stores 838 (as discussed above). The display devices 820 that can be used to display content, e.g., a user interface of an output application as described herein. Display device 820 can be connected to device 800 via local connections (e.g., display bus) and/or via networked connections and can be any suitable display device. Display device 820 can include any suitable display device such as an LCD, LED, or plasma display screen, CRT, television, monitor, touchscreen, 3-D display screen, or other visual display device. For example, display device 820 can be a flat display screen provided on a mobile device, multiple display screens provided in a goggles or headset device, or a monitor screen for a computer device.

The I/O interface 806 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 8 shows one block for each of processor 802, memory 804, I/O interface 806, and software blocks 808, 812, and 830. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While some components are described as performing blocks and operations as described in some implementations herein, any suitable component or combination of components of environment 100, device 800, similar systems, or any suitable processor or processors associated with such a system, may perform the blocks and operations described.

In some implementations, the asset management system can include a machine-learning model (as described herein) for tuning the system (e.g., selecting asset management parameters and corresponding thresholds) to potentially provide improved accuracy. Example machine-learning model input can include labels for a simple implementation and can be augmented with descriptor vector features for a more advanced implementation. Output of the machine-learning module can include a prediction of asset management parameters, asset growth or profitability.

One or more methods described herein (e.g., method 200 and/or 300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method comprising:
generating an asset data structure corresponding to an asset;
capturing one or more asset divisions and one or more details corresponding to one of the one or more asset divisions;
converting the one or more asset divisions into an asset data structure element within the asset data structure;
storing the one or more details corresponding to one of the one or more asset divisions into the asset data structure element that corresponds to the one of the one or more asset divisions;
continuing the capturing, converting and the storing for each asset division and asset detail within the asset;
programmatically analyzing data in the asset data structure to generate a scope of work for the asset;
generating a financial analysis based on the scope of work;
when the asset moves from a prepurchase evaluation phase to a stabilization phase after purchase, generating work task items from corresponding details in the asset data structure that indicate a work operation is needed and tracking financial information about the asset;
receiving operational and maintenance data during a stabilized operational phase;
generating an asset analysis based on the operational and maintenance data;
generating an asset analysis for a prospective buyer of the asset; and
when the asset is sold, providing electronic asset records to the buyer for continued operation of the asset.

2. A computer-implemented method, comprising:
generating, in an asset management system, an asset data structure corresponding to an asset, wherein the asset is a real property, and wherein one or more components of the data structure correspond to one or more physical elements of the asset; and
generating a tree view of the asset data structure including one or more visual elements based on data in the asset data structure, wherein the tree view includes a hierarchical arrangement of graphical user interface elements corresponding to a physical hierarchy within the asset.

3. The computer-implemented method of claim 2, wherein the tree view includes one or more visual elements based on data in the asset data structure and corresponding to one of occupancy status, collections, or overall project, and wherein the tree view includes details associated with each of the one or more visual elements.

4. The computer-implemented method of claim 2, wherein the tree view includes one or more visual elements based on data in the asset data structure and corresponding to one of occupancy status, collections, or overall project, and wherein the visual elements include an element having a stock ticker format.

5. The computer-implemented method of claim 2, wherein the asset is a property, and the method includes generating a tree view of the asset data structure, wherein the tree view includes a tree view of the property visualized in a virtual environment with live camera feed integration of one or more cameras located on the property.

6. The computer-implemented method of claim 2, wherein the asset is a property, and the method includes generating a tree view of the property, where the tree view includes an actionable list of one or more of a task, a maintenance item, a charge, or an expense for each instance.

7. The computer-implemented method of claim 2, wherein the asset is a property, and the method includes generating a tree view of the property that permits a next tenant to be tracked for each unit for rent to maximize revenue.

8. The computer-implemented method of claim 2, wherein the asset is a property, and the method includes generating a checkerboard view of the asset data structure, wherein a visual aspect of each square in the checkerboard view corresponds to a metric based on data within the asset data structure.

9. The computer-implemented method of claim 2, wherein the asset is a property, and the method includes generating a three-dimensional layout view of the asset, wherein a visual aspect of each feature of the three-dimensional layout view corresponds to a metric based on data within the asset data structure, and wherein a location of materials and people are tracked and displayed on the three-dimensional layout.

10. The computer-implemented method of claim 2, wherein the asset is a property containing one or more rental units, wherein the asset data structure contains rental data for each rental unit stored in a division of the asset data structure corresponding to a respective rental unit, and wherein the rental data can include one or more users associated with a rental unit, a current occupant of the rental unit, a previous occupant of the rental unit, and a next occupant of the rental unit.

11. The computer-implemented method of claim 2, wherein one or more details corresponding to one of the one or more asset divisions includes custom data types capturing an as is condition and user specific workflows for the asset.

12. The computer-implemented method of claim 2, wherein one or more details include one or more custom data types creatable and configurable through voice recognition processing.

13. The computer-implemented method of claim 2, wherein one or more details include one or more custom data types creatable and configurable through image recognition.

14. The computer-implemented method of claim 2, wherein one or more details include one or more custom data types creatable and configurable through association based on a machine-readable indicium.

15. The computer-implemented method of claim 2, wherein one or more details include one or more custom data types creatable and configurable based on geographical tracking from a mobile device.

16. The computer-implemented method of claim 2, wherein one or more details include one of scope of work, a quote, a purchase order, an invoice for estimation, project tracking, oversite, verification, and auto report generation.

17. The computer-implemented method of claim 2, further comprising referencing of property, details, scope, purchase order, or invoice through a machine-readable indicium.

18-26. (canceled)

27. A computer-implemented method, comprising:
generating, in an asset management system, an asset data structure corresponding to an asset, wherein the asset is a real property, and wherein one or more components of the data structure correspond to one or more physical elements of the asset;
generating a tree view of the asset data structure including one or more visual elements based on data in the asset data structure, wherein the tree view includes a hierarchical arrangement of graphical user interface elements corresponding to a physical hierarchy within the asset;
when the asset moves from a prepurchase evaluation phase to a stabilization phase after purchase, generating work task items from corresponding details in the asset data structure that indicate a work operation is needed and tracking financial information about the asset, wherein the work task items are displayed in the tree view within an operations user interface section corresponding to an element of the tree view associated with a given one of the work task items;
receiving operational and maintenance data during a stabilized operational phase; and
generating one or more of an asset analysis or financial data based on the operational and maintenance data, wherein the asset analysis includes analysis data corresponding to the one or more physical elements of the asset and the financial data includes financial data values corresponding to the one or more physical elements of the asset, and wherein the tree view includes one or more visual elements representing the analysis data or the financial data values.

28. The computer-implemented method of claim 27, wherein the tree view includes one or more visual elements based on data in the asset data structure and corresponding to one of occupancy status, collections, or overall project, and wherein the tree view includes details associated with each of the one or more visual elements.

29. The computer-implemented method of claim 27, wherein the tree view includes one or more visual elements based on data in the asset data structure and corresponding to one of occupancy status, collections, or overall project, and wherein the visual elements include an element having a stock ticker format.

30-73. (canceled)
